(19) United States
(12) Patent Application Publication
(10) Pub. No.: US 2016/0009469 A1
(43) Pub. Date: Jan. 14, 2016

(54) CLAMP FOR PIPE FASTENING

(71) Applicant: TIGRE S.A. - TUBOS E CONEXÕES, Joinville, Santa Catarina (BR)

(72) Inventors: Cintia MELINA SCHNEIDER DE OLIVEIRA, Joinville (BR); Carlos ROBERTO LEMOS HOMEM DE MELLO, Joinville (BR); Paulo BATISTA FELIPPE, Joinville (BR)

(21) Appl. No.: 14/431,641

(22) PCT Filed: Sep. 6, 2013
(86) PCT No.: PCT/BR2013/000346

§ 371 Date: Aug. 3, 2015

(30) Foreign Application Priority Data
Sep. 26, 2012 (BR) BR 10 2012 024461

(51) Int. Cl. B65D 63/10; F16L 3/137; F16L 55/04

(52) U.S. Cl. CPC B65D 63/1027; F16L 55/04; F16L 3/137; B65D 2563/107; B65D 2563/108

(57) ABSTRACT

Generally speaking, the present disclosure refers to a tube holding means and, more specifically, the present disclosure refers to a clamp (1) to hold hoses, pipes and the like. In conformity with one embodiment of the present disclosure, the tube holding clamp comprises a supporting means (2) consisting of a base (3) associated with a support (4); at least one strip (5) laterally extending from the supporting means and associated with said supporting means (2); and a releasable locking means (6) of said strip.

### PRIORITY CLAIM

This application claims priority to and the benefit of PCT/BR2013/000346, filed Sep. 26, 2013, the entire contents of which is hereby incorporated by reference and relied upon.

### FIELD OF THE PRESENT DISCLOSURE

Generally speaking, the present disclosure refers to a tube holding mechanism and, more specifically, the present disclosure refers to a clamp to hold hoses, pipes and the like.

### BACKGROUND

Tubes, pipes, hoses, conduits, etc. are generally used to organize, protect and/or convey a fluid or material, and are strictly related to the field of buildings, hydraulic, electric and ventilation installations, among others.

In conformity with this specification, the terms tube, pipe, hose, conduit, etc. and their variants are interchangeably used and refer to hollow elements usually endowed with a cylindrical wall and intended to contain a medium, such as fluid or matter, and allow same to be conveyed.

Several manners to attach pipes to structures are known, and they are normally used in visible pipes horizontally displaced along walls and ceilings or vertically displaced along walls or also attached to structures with specific slope, the most used holding mechanism being clamps.

Some embodiments of tube holding clamps, usually made of metal, are known, such as “Omega” clamps which are tube supporting strips whose extremities are folded and attached to the structure; “D” clamps which are strips attached to the structure through a central portion and whose extremities are joined surrounding the tube; and “Drop” clamps which surround the tube and whose extremities are overlapped and attached to the structure.

Clamps with separate components are also known, such as “horizontal joint” clamps, in which a first component is usually held to the structure and a second component, supporting the tube is held to the first component. Another known type of clamp is the “vertical joint” type, in which the two components are joined and surround the tube, and this set is attached to the structure by a third component.

The aforementioned clamp types are usually sold in specific sizes and are not adjustable, since technical knowledge and detailed analysis of both tube diameter and of each point are required.

Besides the various modes for attaching clamps to the structures, some mechanisms to lock the clamps to the tubes are known. For instance, U.S. Pat. No. 6,247,206 discloses a clamp with a locking mechanism in which the adjustment is carried out with a specific tool.

However, one of the currently known problems, which also affects the aforementioned state of the art clamps, is related to self-adjustment and efficient attachment of the pipe in the clamp as well as to pipe servicing, since the currently known locking modes do not allow the clamp to be unlocked or do not allow clamps to be quickly locked and unlocked in an efficient manner.

When the clamps are permanently attached to the tube, that is, they cannot be unlocked, any servicing or need to remove the tube is impaired, since they are time-consuming and expensive, requiring the replacement of the clamps or the tube itself, plus the need to use specific tools to remove the previously installed clamps.

In the case of clamps which can be unlocked, as in the aforementioned state of the art document, locking is not efficient since pipe vibration or accidental impacts may disconnect or break the latch attached to the housing on the other strip, which can be easily verified by a person skilled in the art.

Especially hydraulic pipelines present problems with vibration and noise. This type of problem gets worse when there are gaps between the holding mechanism and the tubes and/or structures. These gaps can be caused by the holding mechanism or inefficient adjustment, which does not allow a precise and firm adjustment.

In view of the foregoing, we have concluded that the known tube holding mechanisms present limitations, mainly related to servicing and also to vibration insulation and adjustments subsequent to installation. This disclosure aims at circumventing these drawbacks, among others.

### SUMMARY

In order to achieve the aforementioned object, among others, the present disclosure refers to a clamp which comprises:

a supporting mechanism including a base associated with a support;

at least one strip laterally extending from the supporting mechanism and associated with the said supporting mechanism; and

a releasable locking mechanism of said strip.

In conformity with additional or alternative embodiments of the present disclosure, the following characteristics, alone or in technically possible combinations, can also be present:
the clamp comprises two strips;
said strips are associated with said supporting mechanism and extend laterally opposite to each other from said supporting mechanism;
said two strips are associated with the base of the said supporting mechanism;
said strips are associated with the support of said supporting mechanism;
at least one strip comprising a knurled surface;
at least another strip comprising said releasable locking mechanism;
said locking comprises a hitch to engage said knurled surface;
said hitch comprises a flap to allow same to be released;
said clamp is a single piece;
said base of the supporting mechanism also comprises a hole to insert a fastening element;
said fastening mechanism is a screw associated with a mounting plate, a screw or a pin with a threaded end;
said supporting mechanism is a tube support and comprises a curved surface;
said support of the supporting mechanism also comprises an opening for passing a tool therethrough;
said clamp also comprises a damping mechanism;
said clamp comprises a damping mechanism;
said damping mechanism comprises a curved surface which adapts itself to the inner surface of the clamp when closed; and
said damping mechanism also comprises a pad to fit into the opening provided on the support of the supporting mechanism.

### BRIEF DESCRIPTION OF THE DRAWINGS

The objects, advantages, technical and functional improvements of this disclosure will be better understood upon reading its description of particular embodiments, presented below and referring to the accompanying figures. These figures are schematic and their sizes and proportions may not correspond to reality, since they aim at exemplarily describing only the present disclosure and do not impose any limitations apart from those defined by the claims described below:

FIG. 1 shows a first perspective view of a clamp in conformity with a first embodiment of the present disclosure;

FIG. 2 shows a second perspective view of the clamp in conformity with FIG. 1, with locked strips;

FIG. 3 shows a damping mechanism for a clamp in conformity with an additional embodiment of the present disclosure;

FIG. 4 shows a perspective view of the clamp of FIG. 1, associated with the damping mechanism of FIG. 4, holding a tube;

FIG. 5 shows a perspective view of the clamp with damper, held to a structure and with a tube held therein;

FIGS. 6 and 7 show a cross-sectional side view of a locking mechanism in locked and unlocked status, respectively; and

FIG. 8 shows a perspective view of a clamp in conformity with a second embodiment of the present disclosure.

### DETAILED DESCRIPTION

The particular embodiments of the present disclosure are described herein with reference to the attached figures. In the figures and in the following description, similar parts are indicated with the same reference number in the specification and figures. The figures are not necessarily to scale. Certain characteristics of the present disclosure may be over-scaled or somehow schematic, and some details of conventional elements may be absent, for the sake of clarity and conciseness of this description. This disclosure is susceptible to different embodiments. Particular embodiments are described in detail and shown in the figures, so that this description is considered an exemplification of the principles of the present disclosure and does not limit the disclosure to what is illustrated and described in this specification. Note that the different teachings of the embodiments discussed below can be used separately or in any suitable combination to produce the same technical effects.

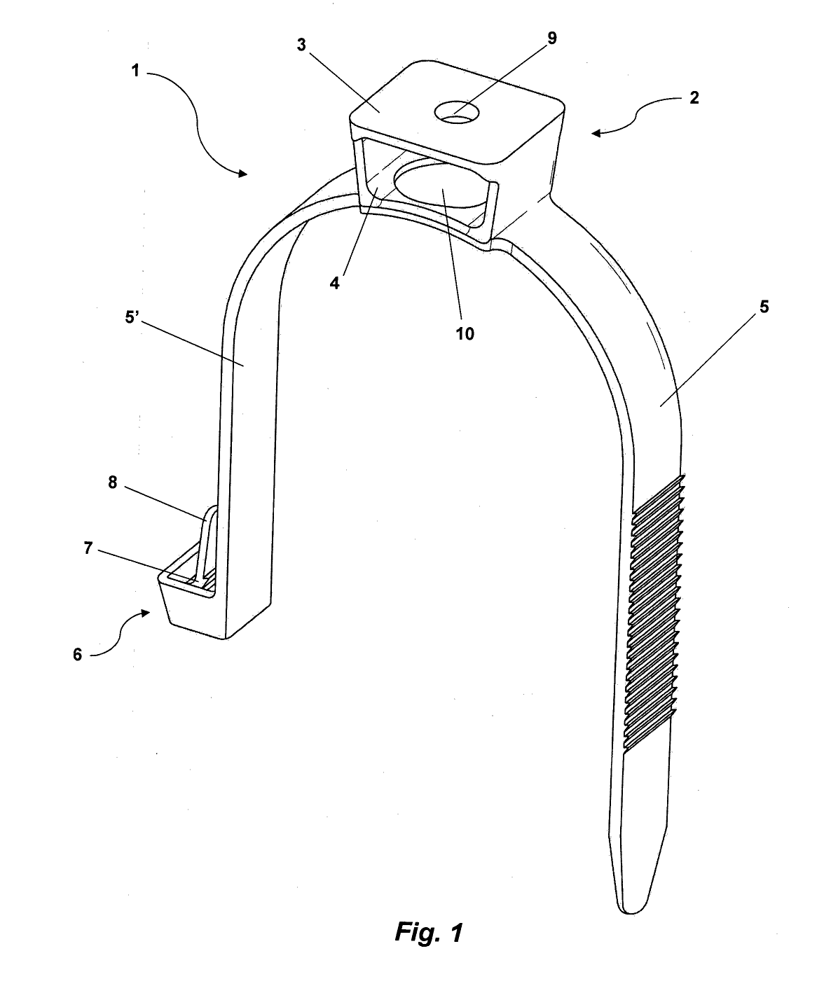

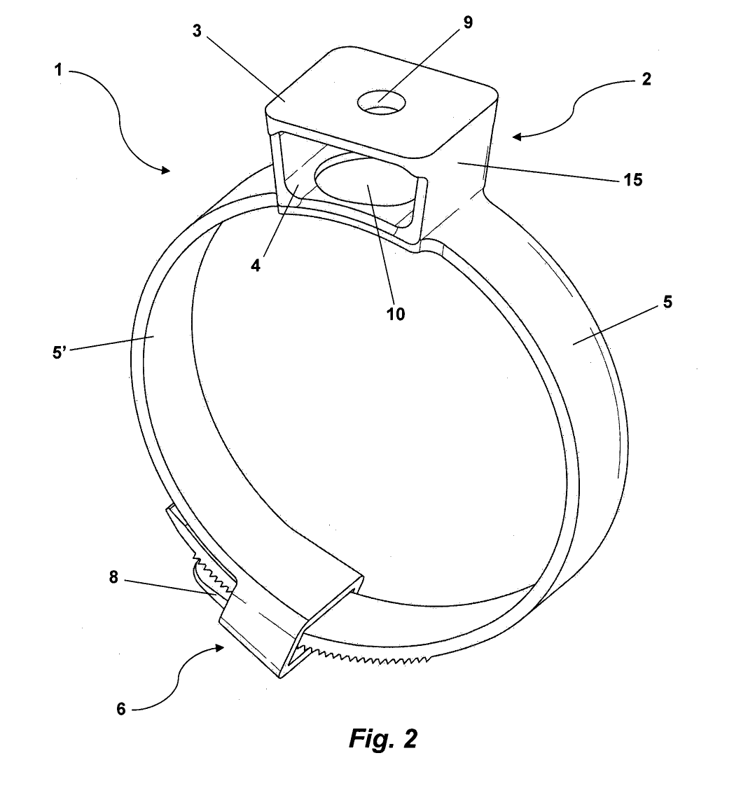

In a first embodiment, as illustrated in FIGS. 1, 2 and 5, the clamp comprises a supporting mechanism 2 made of a base 3 associated with a support 4. Base 3 can be associated with support 4 by sidewalls 15 which extend from the base to the support. As a matter of fact, other association mechanisms between the base and the support can also be provided, such as front and rear walls, or elastic mechanisms such as strips or cords, etc.

Base 3 is flat and leans on a structure, such as a wall, and it supports the clamp which is attached to the tube. Accordingly, the base supports and sustains the set formed by the clamp and tube 16.

Support 4 supports or sustains tube 16, which is inserted in and attached to the clamp. In a particular embodiment, the inner surface of the support can comprise a curvature so to better accommodate the curvature of tube 16.

Additionally, supporting mechanism 2 comprises at least a strip 5 and, in particular, two strips 5 and 5′ which extend laterally and opposite to each other, in which one of the ends of the strip is associated with the supporting mechanism and the other end is free to be fastened to the locking mechanism, which will be clearer from the description below.

In conformity with a first embodiment of the present disclosure, the strips are associated and extend from the sides of support 4, as shown in FIGS. 1, 2, 4 and 5. In conformity with one alternative embodiment, shown in FIG. 8, strips 5 and 5′ are associated and extend from the opposite sides of base 3 of the clamp, while support 4 remains associated with the base, forming supporting mechanism 2.

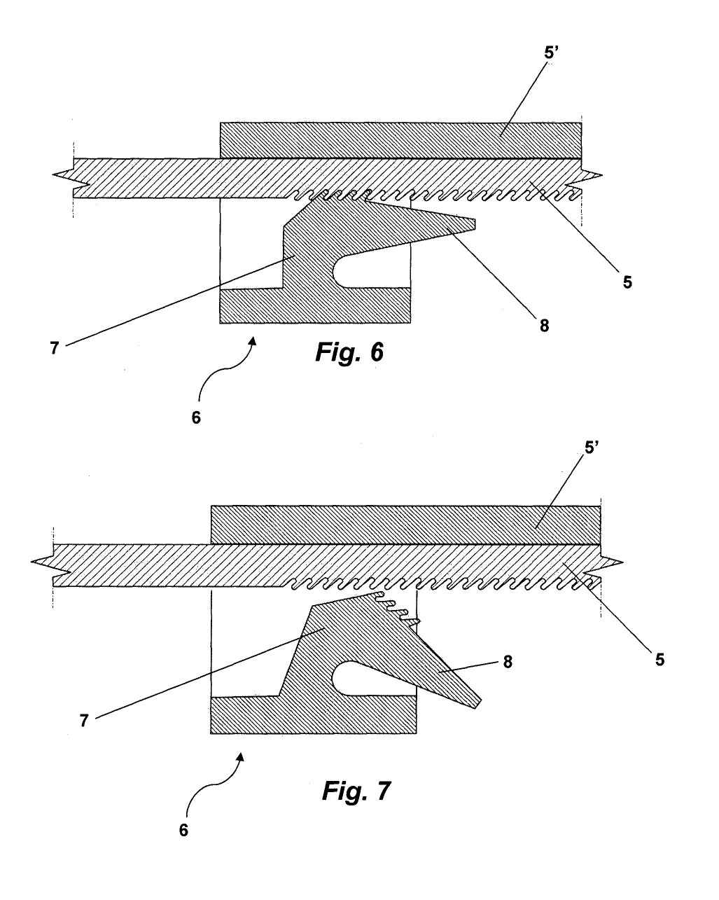

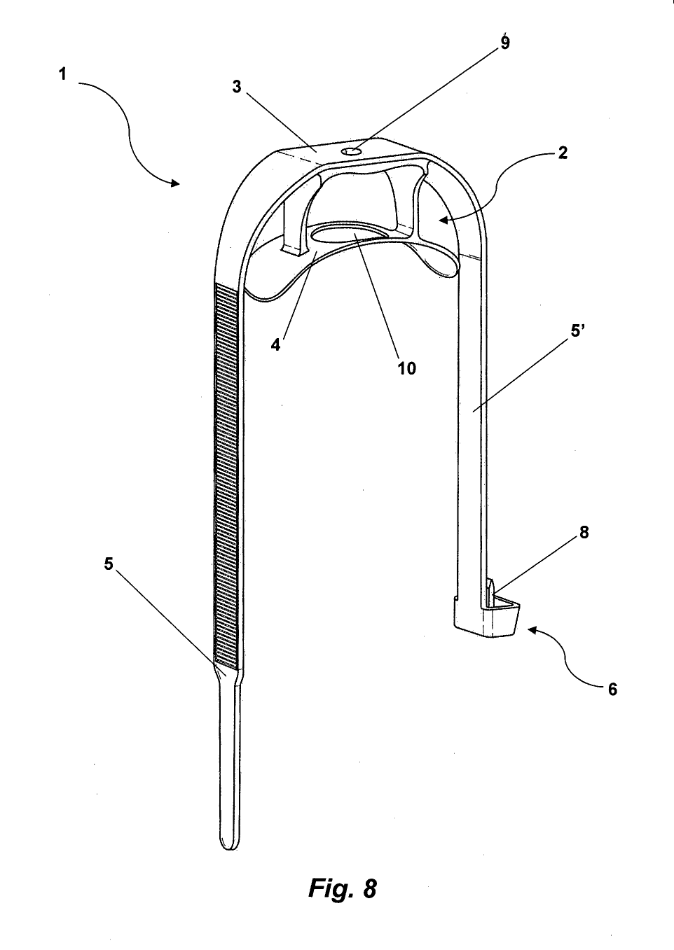

The clamp of the present disclosure also comprises a releasable locking mechanism. The term “releasable locking mechanism” comprises any mechanism allowing strip 5 to be locked to and unlocked from the other strip 5′. In conformity with the herein described particular embodiment, the locking mechanism is made by interlocking a knurled surface with the correspondent hitch. Accordingly, a first strip 5 is endowed with a knurled surface, and the other strip 5′, extending from the opposite side of supporting mechanism 2, is endowed with a stop comprising a hitch 7 which also comprises a corresponding knurled surface so to be fasted to the knurled surface of the strip, as shown in details in the section of FIGS. 6 and 7. In particular, the knurled surfaces of both the strip and the hitch 7 present a slope so that, on one hand they let a strip pass through the hitch without stopping in one direction and, on the other hand, they stop the strip when moved or pulled to another direction. Accordingly, for instance, strip 5 can pass through the hitching mechanism towards the closing direction of the clamp, but it holds the hitch if moved towards the opposite direction with respect to the clamp opening.

In order to allow an easy release of the strips, upon interconnecting the strips, hitch 7 of locking mechanism 6 can comprise a flexible characteristic, that is, it can be moved from a position of rest in which it is in contact with the knurled surface of strip 5, as shown in FIG. 6, to a position of strip release, in which the knurled surfaces of the strip and hitch 7 are no longer in contact with each the other and, thus, strip 5 can be easily removed and the clamp can be easily opened, as shown in FIG. 7. Furthermore, so that the clamp can be easily opened, hitch 7 can also comprise a flap 8 which extends from the inner portion of locking mechanism 6 towards the outer portion thereof, so to allow the release of the stop without the need for any tools.

In conformity with one additional embodiment, support 4 also comprises an opening 10 allowing the passage of a tool which can be used to hold clamp 1 on a structure by providing opening 9, for instance, on base 3. Fastening can be accomplished, for instance, by a screw with a bushing and a washer. However, these openings can be eliminated when other fastening mechanisms such as but not only glues, hook and loop, epoxy, etc. are used,

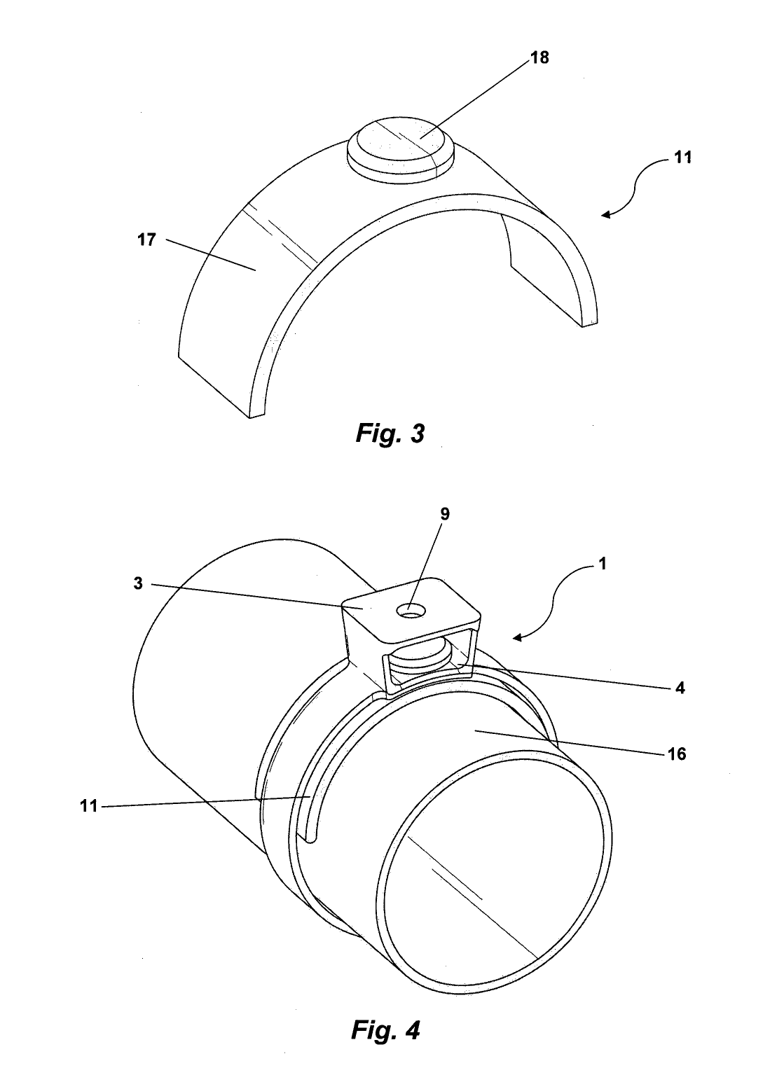

The clamp of the present disclosure may also comprise a damping mechanism, as shown in FIG. 3. In particular, the damping mechanism is provided to fit into and be accommodated in the upper inner portion of the clamp which may comprise a curved surface 17, including a semi-arch molded to the circumference formed by the clamp when is closed to enclose the tube (FIG. 4) and, in order to preventing the damping mechanism from moving or getting loose from the clamp, it may also comprise a pad 18 projecting from the curved surface and intended to fit into opening 10 provided on the support of supporting mechanism 2. The damper can be made of any material suitable for absorbing vibrations, such as an elastomer.

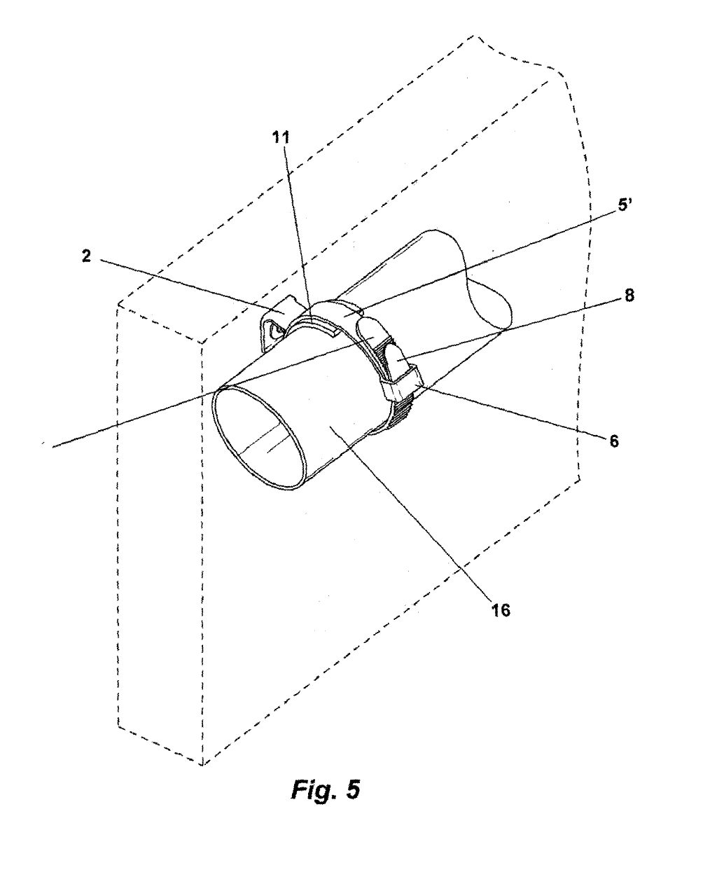

FIG. 5 shows a tube attached to a structure plane by the clamp in conformity with one of the embodiments of the present disclosure. The fastening operation of the tube on a structure plane is initially done by fastening the clamp to the structure plan through, for instance, a screw with bushing and washer, which is fastened by hole 9 provided on base 3 of supporting mechanism 2. The tool to fasten the screw can pass through opening 10 provided on support 4 of supporting mechanism 2. Therefore, damping mechanism 11 is inserted and fit into opening 10 provided on support 4 of supporting mechanism 2 and, subsequently, tube 16 is placed in position. Strips 5 and 5′ are closed and locked by locking mechanism 6 and tightened until the tube is efficiently locked. If tube removal is needed, the release of the strips is accomplished by manually adding flap 8 of locking mechanism 6.

Preferably, the clamp of the present disclosure is a single piece, in particular, a thermoplastic polymer, such as polyurethane, PVC, polystyrene, polypropylene, PET, etc.

Although the present disclosure has been described based on its particular embodiments, note that variations may be performed with respect to what was referred above without departing from the scope of the present disclosure. Although the specific embodiments have been shown and described, amendments may be made by a person skilled in the art without departing from the essence or teachings of this disclosure. Embodiments as those described herein have a simple explicative function and are not limitative. Several variations of amendments are possible and are included in the scope of the present disclosure. Thus, the scope of protection is not limited to the embodiments described, but is only limited by the following claims, whose scope must include all the equivalents.

1. A tube holding clamp comprising:
a supporting means consisting of a base associated with a support;
at least one strip laterally extending from the supporting means and associated with said supporting means; and
a releasable locking means of said strip.

2-17. (canceled)

18. The clamp according to claim 1, which includes two strips associated with said supporting means which extend laterally and opposite to each other from said supporting means.

19. The clamp according to claim 18, wherein the strips are associated with said supporting means in that they extend from opposite sides of said supporting means.

20. The clamp according to claim 18, wherein the strips are associated with at least one of: (i) the base of said supporting means; and (ii) the support of said supporting means.

21. The clamp according to claim 1, wherein the at least one strip comprises a knurled surface.

22. A tube holding clamp comprising:
a support;
a base associated with the support;
at least one strip laterally extending from the support or the base; and
a releasable locking mechanism of the at least one strip.

23. The clamp according to claim 22, which includes two strips which extend laterally and opposite to each other from the support or the base.

24. The clamp according to claim 23, wherein the strips are associated with the base.

25. The clamp according to claim 23, wherein the strips are associated with the support.

26. The clamp according to claim 22, wherein the at least one strip comprises a knurled surface.

27. The clamp according to claim 23, wherein a second strip of the two strips comprises the locking mechanism.

28. The clamp according to claim 26, wherein the locking mechanism comprises a hitch to engage the knurled surface.

29. The clamp according to claim 28, wherein the hitch comprises a flap which allows the hitch to be released.

30. The clamp according to claim 22, which is integrally formed from a single piece of material.

31. The clamp according to claim 22, wherein the base additionally comprises a hole to insert a fastening element.

32. The clamp according to claim 22, which is configured to hold tubes having different diameters.

33. The clamp according to claim 22, wherein the support is a support for a tube and presents a curved surface.

34. The clamp according to claim 22, wherein the support comprises an opening to allow tools to pass therethrough.

35. The clamp according to claim 22, which includes a damping mechanism comprising a curved surface to be adapted to the inner surface of the clamp when it is closed.

36. The clamp according to claim 22, which includes damping mechanism comprises a pad to fit into an opening provided on the support.
